(19) United States
(12) Patent Application Publication
(10) Pub. No.: US 2003/0168871 A1
(43) Pub. Date: Sep. 11, 2003

(54) Lifting device

(76) Inventor: Gerhard Geis, Hosbach (DE)

Correspondence Address: VENABLE, BAETJER, HOWARD AND CIVILETTI, LLP, P.O. BOX 34385, WASHINGTON, DC, 20043-9998, US

(21) Appl. No.: 10/089,381

(22) PCT Filed: Dec. 22, 2001
(86) PCT No.: PCT/EP01/15297

(30) Foreign Application Priority Data
Jan. 18, 2001 (DE) 101 01 986.6
Apr. 20, 2001 (DE) 101 19 273.8
Aug. 17, 2001 (DE) 101 40 449.2

(51) Int. Cl. B66C 1/66

(52) U.S. Cl. 294/81.21; 294/81.53

(57) ABSTRACT

The invention relates to a lifting apparatus (1) for transporting a container, said device comprising a main frame (2) and two shuttle booms (3). Respectively one shuttle boom (3) that ends on one longitudinal-side end of the main frame (2) is positioned such that it can be displaced in longitudinal direction of the main frame (2). Holders for attaching the container are provided at the free longitudinal-side ends of the shuttle booms (3). The shuttle booms (3) are operated with the aid of drum motors (44). The shuttle booms (3) are guided by means of roller bearings in the main frame (2).

The invention relates to a lifting apparatus in accordance with the preamble to claim 1.

Lifting apparatuses of this type are used for transporting containers, in particular in port facilities.

These lifting apparatuses called spreaders comprise a stationary main frame with two shuttle booms guided therein. The shuttle booms respectively start at one exit opening on one longitudinal end of the main frame and can be displaced in longitudinal direction of this frame.

Holders for attaching the respective container are located at the free longitudinal ends of the shuttle boom. Each free end of the shuttle boom is provided with a separate headpiece. A locking pin that respectively forms a holder is located at the two ends of the headpiece that project on the side over the shuttle boom. These locking pins are used for attaching the lifting apparatus to the container.

Corner guides are provided as additional holders for positioning the lifting apparatus on the container. The corner guides are located immediately adjacent to the locking pins.

With known lifting apparatuses, hydraulic drives are used to realize the displacement movement of the shuttle boom within the main frame. A hydraulic drive of this type comprises at least one hydraulic motor with a hydraulic pump. Power is transmitted via steel chain links from the hydraulic motor to a shuttle boom.

During the displacement movement, the shuttle boom made of steel is guided with its back end inside the main frame, wherein a lubricating grease cushion is provided between the walls of the main frame and the shuttle boom to reduce the sliding friction between the contacting surfaces.

The holders, in particular the locking pins, are also driven hydraulically. The corner guides can optionally be connected rigidly to the respective headpiece.

Lifting apparatuses of this type have the disadvantage of a high-energy requirement for operating the movable units, especially the shuttle booms. In particular, this is due to the fact that energy must be supplied continuously to the hydraulic drives, even if the units are not moved.

The high-energy requirement also results from the high inherent weight of the shuttle booms, thus resulting in considerable sliding friction forces effective between shuttle boom and main frame.

Another disadvantage of lifting apparatus of this type is that leaks frequently occur in the hydraulic system during the operation. In addition, the grease for the lubricant bolster between shuttle booms and main frame is unavoidably pushed out of the lifting apparatus. This causes considerable soiling of the lifting apparatus and the containers to be transported, which results in an undesirably high expenditure for cleaning and maintenance operations. Furthermore, the hydraulic system leaks require a considerable expenditure for maintenance operations. Finally, the high amount of grease and oil escaping at the lifting apparatus results in high environmental impact.

It is the object of the invention to provide a lifting apparatus of the aforementioned type, which can be operated with low energy and maintenance expenditure.

With the lifting apparatus according to the invention, the shuttle booms and/or the holders for connecting the lifting apparatus to a container are operated with an electric drive. In addition, the shuttle booms are guided inside the main frame by means of roller bearings.

One essential advantage of this lifting apparatus is that hydraulic drives can be omitted completely because electric drives are used. The danger of leakage, which can occur with hydraulic drives, is consequently avoided and the soiling of the lifting apparatus and the containers is reduced considerably. The electric drives are furthermore nearly maintenance-free and additionally permit a highly precise positioning of the attached units.

The use of electric drives also results in considerable savings in energy. In particular, this is due to the fact that electric drives, unlike hydraulic drives, are supplied with and use energy only if a positioning movement is carried out.

The energy saving is furthermore increased by the fact that the shuttle booms are guided inside the main frame via roller bearings. The border surfaces between main frame and shuttle booms thus are no longer directly adjacent to each other, but are guided without friction via the roller bearings.

An additional advantage therefore is that a lubricating with grease is no longer necessary. No soiling due to grease occurs with the lifting apparatus according to the invention and the maintenance expenditure for the lifting apparatus is reduced.

The electric drive for realizing the displacement movement of a shuttle boom particularly advantageously comprises an electric drive¹ that operates a toothed belt. 1. Note: The sentence in the original German application is confusing. See paragraph 47.

The toothed belt engages in an energy-supply rod at the respective shuttle boom. The use of steel chains for transmitting power, used for hydraulic drives, can be avoided with an electric drive design of this type. A considerable saving in weight and energy is therefore possible and the maintenance expenditure for the lifting apparatus is further reduced.

Additional savings in weight and energy can be achieved with one advantageous embodiment where the shuttle booms are made of a carbon-fiber compound material.

The roller bearings of a different, advantageous embodiment are positioned with springs. The spring positioning results in an efficient shock absorption, particularly when attaching the lifting apparatus to the container, and thus also in a considerable reduction in the noise level. This effect is amplified in that headpieces attached to the free ends of the shuttle booms, on which the holders for attaching the container are arranged, are glued to the shuttle booms. Shock-absorbing Vulkollan² layers are preferably used in that case. 2. Note: This is a trade name and will not be translated.

A modified version of the lifting apparatus according to the invention provides for the use of linear motors as drives for the shuttle booms. The use of linear motors means that no moving parts are required for transmitting the power generated by the drive to the shuttle booms for realizing the displacement movement. The linear drives operate completely without wear and do not require maintenance. In addition, the operation of the lifting apparatus according to the invention is environment-friendly, in particular since no leaks can occur at the linear drives.

It is furthermore advantageous that all components of the linear drives can be installed stationary on the lifting apparatus. The primary component of a linear drive in this case is arranged stationary at the main frame of the lifting apparatus while the secondary component of the linear drive is also arranged stationary on the respective shuttle boom. As a result, the cable feeds to the linear drive components can also be stationary, and the linear drives can be mounted easily and cost-effectively on the lifting apparatus.

The shuttle booms on the lifting apparatus respectively consist of two crossbeams that are advantageously guided inside separate slide-in compartments of the main frame.

One advantageous embodiment provides that a linear drive is assigned to each crossbeam of the shuttle boom. A secondary component in the form of a metal rail extending in its longitudinal direction is provided on each crossbeam. The primary component of the respective linear drive is arranged in or on the slide-in compartment assigned to the crossbeam.

The lifting apparatus designed in this way can be produced extremely cost-effectively. In addition, the use of linear drives results in a narrow structural design for the lifting apparatus, which results in good visual conditions at the lifting apparatus. In turn, this leads to increased safety during the operation of the lifting apparatus.

One modification of the lifting apparatus according to the invention provides for the use of drum motors as drives for the shuttle booms.

Drum motors permit an exact positioning of the shuttle booms while the energy expenditure required for moving the shuttle booms is extremely low. The drum motors can furthermore be operated almost completely without wear.

According to one particularly advantageous embodiment of the invention, friction linings are installed on the outer surfaces of the drums for the drum motors, for example linings made of wear-resistant rubber material or a glass-fiber containing plastic. Friction linings are also installed on the top and bottom surfaces of the energy-supply rods, on which the drums that are pressed on with spring tension roll off.

Thus, a high frictional force is effective between the drums and the energy-supply rod, so that the drums can roll off the energy-supply rods without slipping. It is furthermore advantageous that the friction linings are designed for low wear and, in particular, are wear-resistant, so that the frictional effect between the linings is stable over a long period of time.

The shuttle boom walls of one advantageous embodiment of the invention have a lattice-type design, at least in some sections, and thus have a particularly high stability with low inherent weight.

It is particularly advantageous if this latticework consists of glass fiber materials, carbon compound materials and/or hybrid sandwich-type constructions of several layers of the aforementioned materials. Owing to this type of construction, the stability and inherent weight of a shuttle boom can be further optimized. In particular, the shuttle boom can be optimized purposely with respect to tensile and pressure loads. For this, elements of the shuttle boom that are subjected to tensile loads are primarily made from glass-fiber materials while elements of the shuttle boom that are subjected to pressure loads are primarily constructed from carbon-fiber compound materials.

Another advantageous embodiment of the invention provides for springs in the form of spring leaves for positioning the rollers.

This type of spring support efficiently absorbs any stresses that occur, particularly impact stresses, and also protects the rollers against damage.

The invention is explained in the following with the aid of the drawings. Shown are in:

FIG. 1 A view from above of a lifting apparatus with two shuttle booms guided inside a main frame.

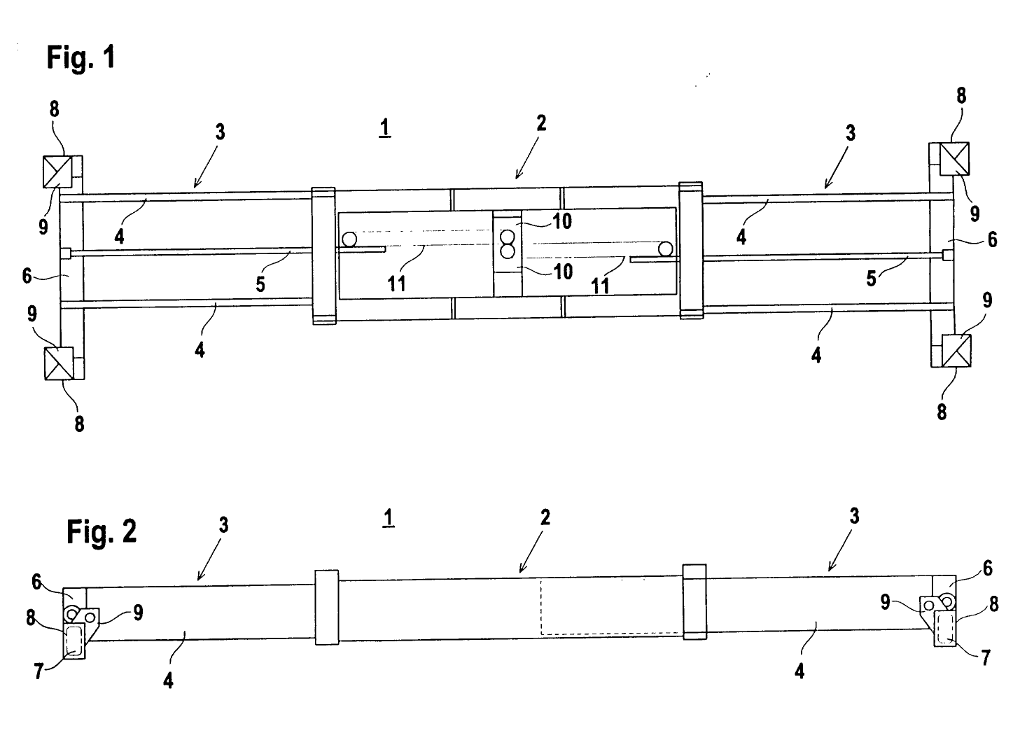

FIG. 2 A view from the side of the lifting apparatus according to FIG. 1.

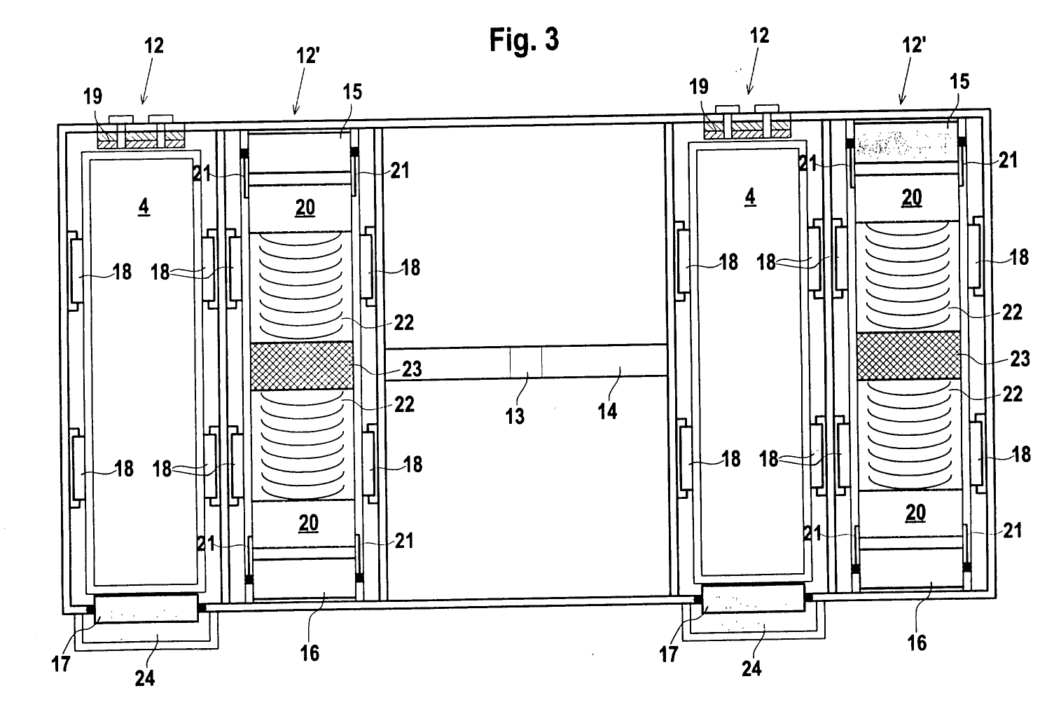

FIG. 3 A cross section through the lifting apparatus according to FIG. 1, with the crossbeams for the shuttle booms extending inside slide-in compartments.

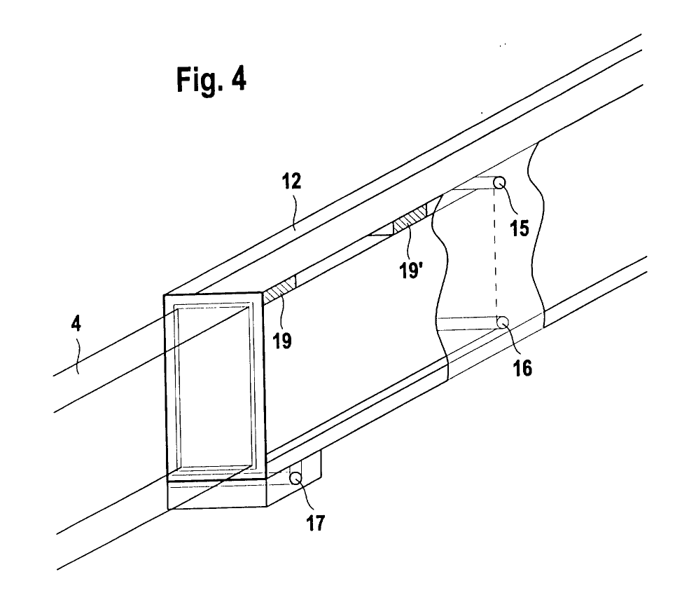

FIG. 4 A perspective view of a crossbeam for a shuttle boom that is guided inside a slide-in compartment.

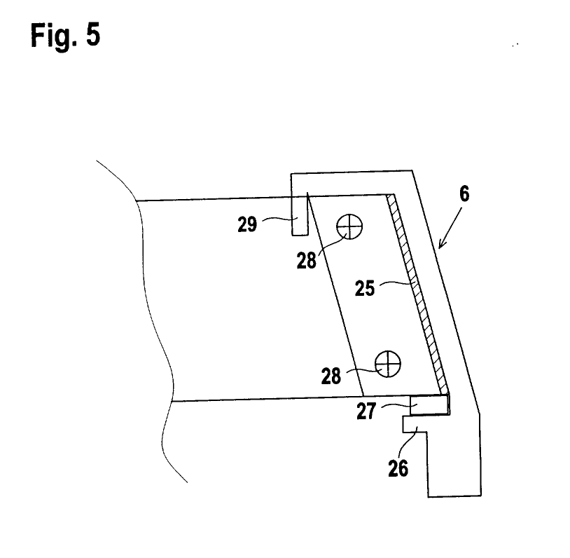

FIG. 5 A cross section through a headpiece attached to a free end of a shuttle boom.

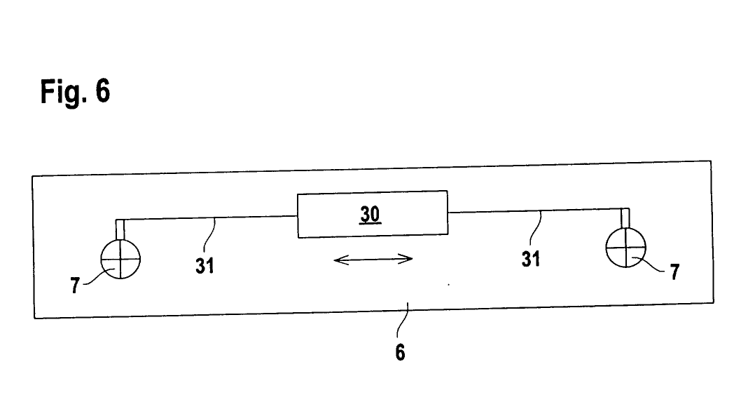

FIG. 6 A schematic representation of two locking pins, arranged on a headpiece and operated with an electric drive.

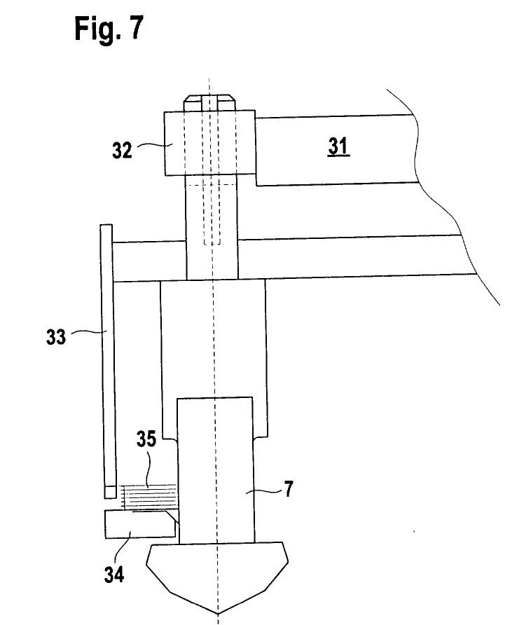

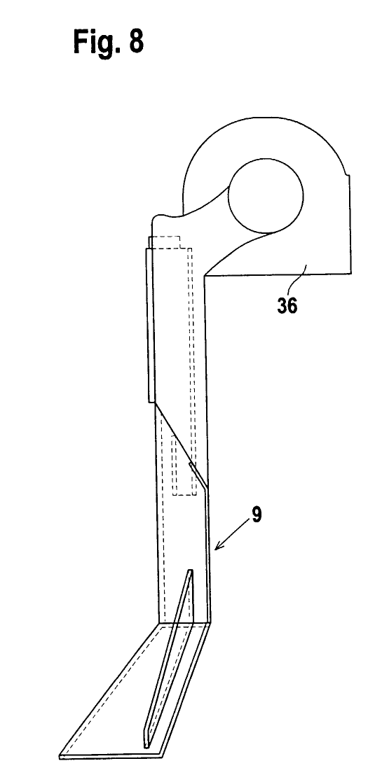

FIG. 7 An exemplary embodiment of a locking pin according to FIG. 6.

FIG. 8 A schematic representation of a corner guide, operated with the aid of an electric drive.

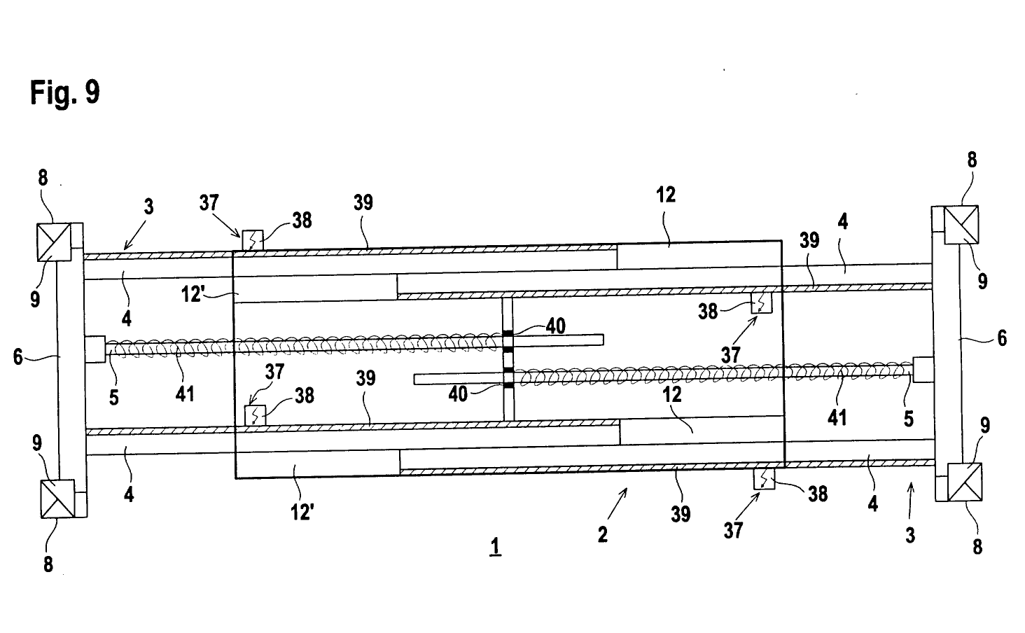

FIG. 9 A view from above of a lifting apparatus with displaceable positioned shuttle booms that are operated with linear drives.

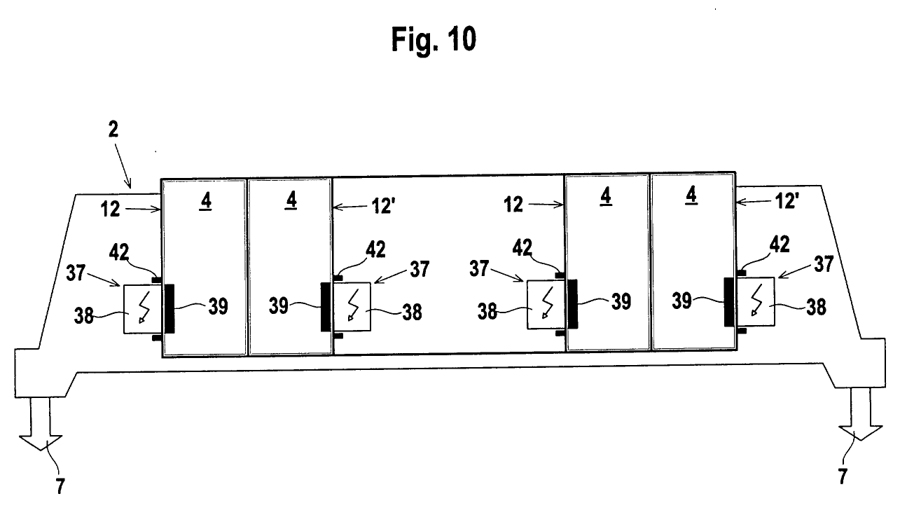

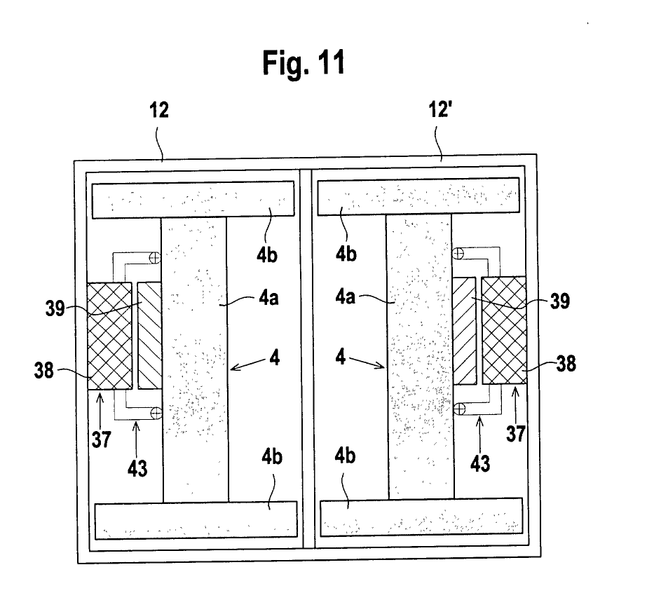

FIG. 10 A cross section through a first lifting apparatus according to FIG. 9.

FIG. 11 A cross section through a second lifting apparatus according to FIG. 9.

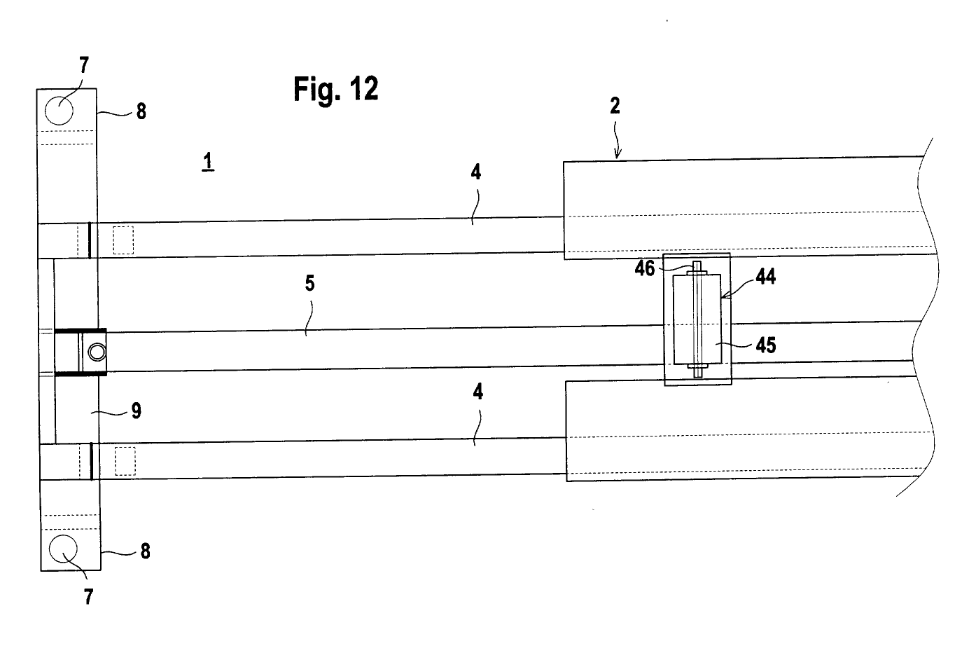

FIG. 12 A view from above of a lifting apparatus with displaceable positioned shuttle booms that are operated with drum motors.

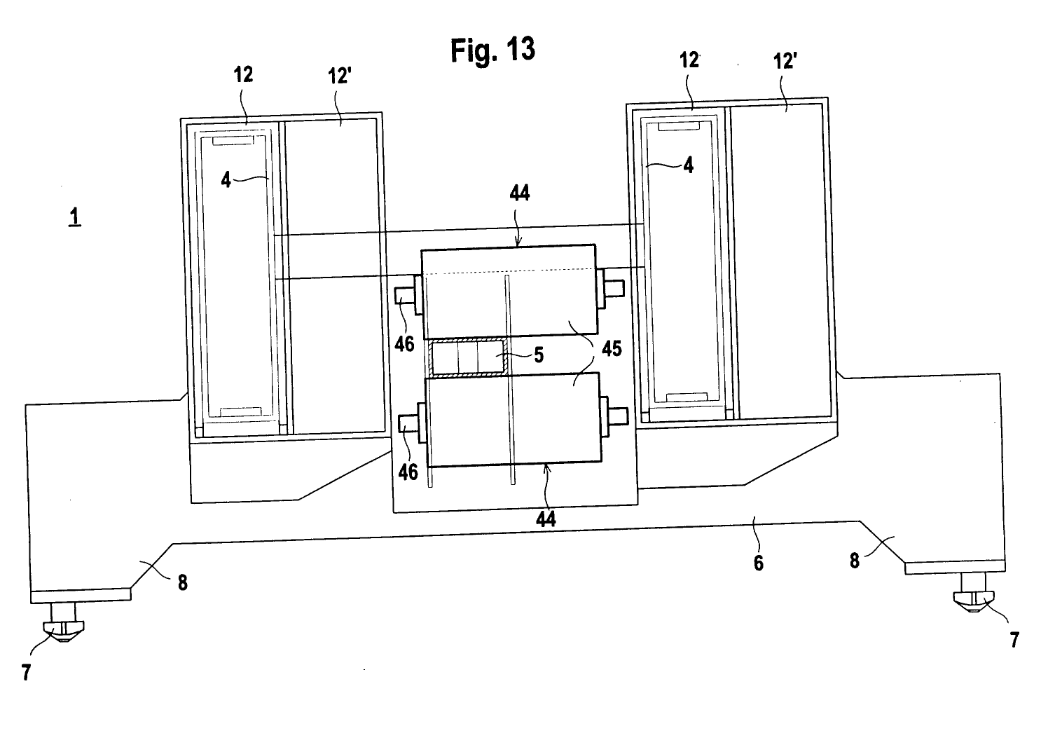

FIG. 13 A cross section through the lifting apparatus according to FIG. 12.

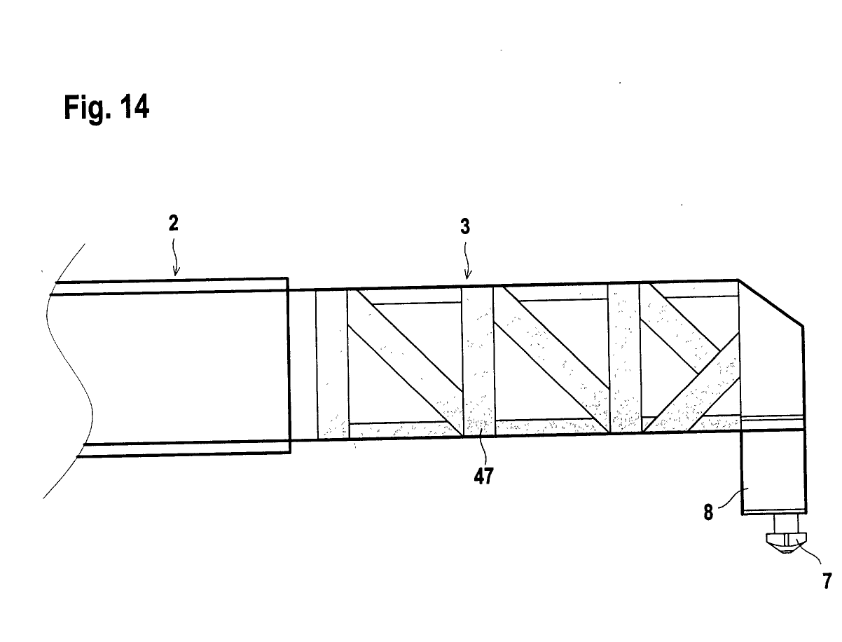

FIG. 14 A view from the side of a shuttle boom with lattice-type construction.

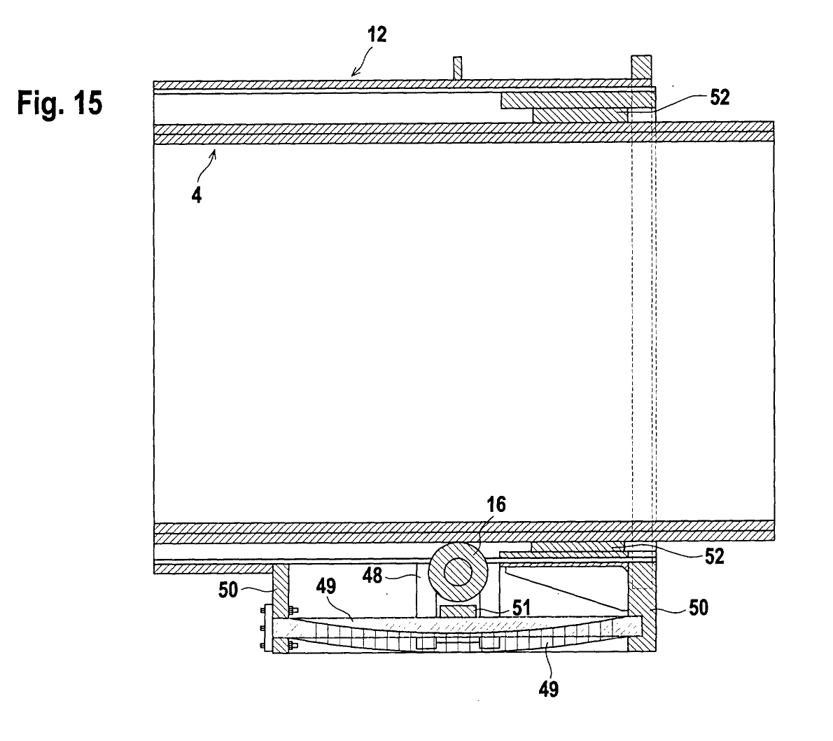

FIG. 15 A spring system for a roller for guiding a shuttle boom.

FIGS. 1-8 show embodiments of the lifting apparatus, which were originally disclosed in the DE 101 01 986.

FIG. 1 shows an exemplary embodiment of a lifting apparatus 1 for transporting containers that are not shown herein.

The lifting apparatus 1 has a main frame 2 with two shuttle booms 3 guided therein. The main frame 2 consists of steel and has an essentially parallelepiped outside contour. Openings are provided at the longitudinal-side ends of the main frame 2, into which the shuttle booms 3 are inserted. The shuttle booms 3 exit at opposite-arranged longitudinal-side ends of the main frame 2 and can be displaced in longitudinal direction of the main frame 2.

The shuttle booms 3 consist of carbon fiber compound materials and essentially have the same design. In this case, each shuttle boom 3 has two crossbeams 4 extending in its longitudinal direction. The crossbeams 4 extend at a distance parallel to each other and respectively have a rectangular cross section.

FIG. 2 shows that the crossbeams 4 essentially have the same height as the main frame 2.

An energy-supply rod 5, which also forms a component of the respective shuttle boom 3, extends between the crossbeams 4 and parallel to these.

FIG. 1 shows that the crossbeams 4 of the first shuttle boom 3 are arranged with a side offset relative to the crossbeams 4 of the second shuttle boom 3, so that these can be pushed past each other inside the main frame 2.

Respectively one headpiece 6 is arranged at the free longitudinal-side ends of the shuttle booms 3, wherein the crossbeams 4 as well as the energy-supply rod 5 for the shuttle boom 3 extend to the headpiece 6. The longitudinal axis of the headpiece 6 extends crosswise to the longitudinal axis of the corresponding shuttle boom 3. Holders for attaching the container are provided at the ends of the headpiece 6, which project on the side over the shuttle boom 3.

Locking pins 7 for one thing function as the holders. A locking pin 7 of this type is arranged inside a casing 8, at each end of a headpiece 6.

The locking pins 7 are used to attach the lifting apparatus 1 to the container. For this, the locking pins engage in corresponding recesses 42?³ at the 3 Note: The ? appears in the original text container and are secured there, so that the containers can be lifted with the lifting apparatus 1.

Corner guides 9 are provided on the headpieces 6 as additional holders for positioning the locking pins 7 inside these recesses 42?. The corner guides 9 are also located at the longitudinal-side ends of headpiece 6, meaning directly adjacent to the locking pins 7.

Electric drives are provided for carrying out the displacement movement of the shuttle booms 3. For the present exemplary embodiment, an electric motor 10 is provided for each shuttle boom 3 as electric drive, which motor drives a toothed belt 11. Each toothed belt 11 is guided and moved with rollers in longitudinal direction of the main frame 2 and engages in the energy-supply rod 5 of the respective shuttle boom 3. The movement of toothed belt 11 is transmitted in this way to the energy-supply rod 5, as a result of which the shuttle boom 3 is displaced. The shuttle boom 3 movement can be precisely specified by predetermining the positioning and speed commands for activating the electric motor 10.

FIG. 3 shows that the crossbeams 4 of shuttle booms 3 are guided inside separate slide-in compartments 12, 12′ of the main frame 2. The slide-in compartments 12, 12′ extend in longitudinal direction of the main frame 2, wherein respectively two slide-in compartments 12, 12′ are arranged directly adjacent to each other along opposite side walls of the main frame 2. The slide-in compartments 12, 12′ have identical designs and are shaped as hollow profiles with rectangular cross sections.

FIG. 3 shows the front of crossbeams 4 of the first shuttle boom 3, which crossbeams extend inside two first slide-in compartments 12 that are arranged at two opposite-arranged side walls of the main chamber. The crossbeams 4 for the second shuttle boom 3, of which the back is shown in FIG. 3, extend inside the two remaining main compartments 12′ with a side offset to the crossbeams 4 of the first shuttle boom 3. The energy-supply rods 5 for the shuttle booms 3 extend inside bores 13 of a transverse girder 14 for the main frame 2, one of which is shown in FIG. 3.

The shuttle booms 3 are guided with roller bearings inside the individual slide-in compartments 12, 12′. The roller bearings comprise several rollers 15, 16, 17, 18 that are arranged at the individual crossbeams 4 of shuttle booms 3 and at the respective slide-in compartments 12, 12′. The rollers 15, 16, 17, 18 are made of polypropylene, rigid expanded polyurethane or metal and are preferably positioned on springs. The arrangement of rollers 15, 16, 17, 18 is identical for all slide-in compartments 12, 12′ and the crossbeams 4 extending therein.

FIG. 4 schematically shows the arrangement of a first, second and third roller 15, 16, 17 for guiding a crossbeam 4 inside a slide-in compartment 12, 12′.

The first roller 15 and the second roller 16 are arranged on the back of the crossbeam 4. For this, the roller 15 is arranged on the top surface of crossbeam 4, such that it projects somewhat over the level top surface and rolls off the facing inside wall of the crossbeam 4. The second roller 16 is arranged correspondingly on the bottom of crossbeam 4.

A third roller 17 is installed in the output region of the main frame 2, such that it rolls off the underside of crossbeam 4.

Buffer plates 19, 19′ are provided on the inside walls of the corresponding slide-in compartment 12, 12′, positioned opposite the top of crossbeam 4, which plates support the crossbeam 4 inside a slide-in compartment 12, 12′. The first buffer plate 19 is positioned opposite the third roller 17 while the second buffer plate 19′ is positioned directly in front of the first roller 15. The buffer plates 19, 19′ project from the inside wall of the slide-in compartment 12, 12′, wherein their structural heights are adapted to the structural height and installation position of the first roller 15, so that this roller can roll off the inside wall of slide-in compartment 12, 12′. The buffer plates 19, 19′ prevent a tilting of the crossbeams 4 inside the slide-in compartment 12, 12′, particularly during the displacement movement of crossbeam 4 and the lifting of the container.

The rollers 15, 16, 17 shown in FIG. 4 respectively have rotational axes extending in horizontal direction and crosswise to the longitudinal axis of the shuttle boom 3. The rollers 15, 16, 17 in this case extend nearly over the complete width of the crossbeam 4.

The positioning of rollers 15, 16, 17 is shown in further detail in FIG. 3.

The first and second roller 15, 16 on the back of the crossbeams 4 of one of the shuttle booms 3 respectively are mounted with a roller bracket 20 on the underside and the top of crossbeam 4. The rollers 15, 16 in this case are always attached with a holder 21 to the roller bracket 20, so that a slight gap remains between the respective roller 15, 16 and the roller bracket 20. Each roller bracket 20 in turn is positioned on a spring 22, wherein the springs 22 sit on a joint support plate 23. The springs 22 are preferably spiral compression springs or silent blocks.

The third roller 17 is also spring-positioned. The third roller 17 is located at the output for the slide-in compartment 12, 12′, wherein the roller 17 is positioned on the underside of slide-in compartment 12, 12′ in such a way that it projects slightly upward over the inside wall of slide-in compartment 12, 12′. The third roller 17 in this case sits on a plastic spring buffer 24.

Slots that are not shown herein are preferably inserted into the undersides of slide-in compartments 12, 12′ and the spring buffers 24 to allow dirt and water to escape through these slots from the respective slide-in compartment 12, 12′.

With the aid of the first, second and third rollers 15, 16, 17, the undersides and tops of crossbeams 4 of shuttle booms 3 are guided inside the respective slide-in compartment 12, 12′. Additional rollers 18 are provided for a side guidance of crossbeams 4, which rollers project from the side walls of the slide-in compartments 12, 12′, as shown in FIG. 3. These rollers 18 can also be spring-positioned.

FIG. 5 shows the free end of a shuttle boom 3 with a headpiece 6 attached thereto. The headpiece 6 in this case is glued to the shuttle boom 3 with a special glue having a strong shock-absorbing effect. A plastic lining or the like 25 is applied between the front of shuttle boom 3 and the inside of the headpiece 6. A holder part for a locking pin 7 that is not shown in FIG. 5 is located on the underside of the headpiece 6. The top of the holder part has a shoulder 26, at a distance to the underside of shuttle boom 3. An additional layer of plastic or the like 27 is inserted into the space between the shoulder 26 and the shuttle boom 3, which layer serves as buffer for cushioning the impact stresses when the headpieces 6 are placed onto the container. Plastic bearings 28 at the shuttle boom 3 serve to further dampen the impact.

The top of headpiece 6 is provided with a projection 29 that points downward and engages in a recess 42? at the shuttle boom 3. The projection can be used to secure the headpiece 6 mechanically to the shuttle boom 3.

FIG. 6 schematically shows an electric drive for positioning two locking pins 7 arranged on a headpiece 6. The electric drive comprises an electric motor 30 and two headpiece push rods 31, of which respectively one leads to a locking pin 7. The headpiece push rods 31 are made of glass-fiber reinforced plastic.

A locking pin 7 of this type, which is connected to a headpiece push rod 31, is shown with further detail in FIG. 7. The horizontally extending headpiece push rod 31 extends via a bearing 32 to the locking pin 7. The longitudinal axis of the locking pin extends in vertical direction. The electric motor 30 functions to stimulate a rotational motion of locking pin 7 via the headpiece push rod 31 and the bearing 32, so that it can be secured inside a recess 42? of a container.

To cushion impacts, a buffer 35 is provided between a vertically extending holder 33 and a solid steel plate 34 on the side of the locking pin 7. The buffer 35 consists of a sandwich structure of steel plates and plastic plates.

FIG. 8 shows an exemplary embodiment of a corner guide 9 that is positioned pivoting on the headpiece 6 and is operated electrically. The corner guide 9 is shaped in the manner of a shovel. In order to perform a pivoting movement, the corner guide 9 is connected to a planetary gear 36 or a worm gear. A rotation magnet can also be provided as alternative to the planetary gear 36. In principle, the corner guides 9 can also be arranged immovably on the respective headpiece 6.

FIGS. 9-11 show exemplary embodiments of the lifting apparatus 1, which were originally disclosed in DE 101 19 273.

A lifting apparatus 1 is shown schematically in FIG. 9, which has essentially the same design as the lifting apparatus 1 shown in FIGS. 1 and 2. The lifting apparatus 1 in particular has two shuttle booms 3, arranged displaceable on a main frame 2. The shuttle booms 3 are respectively provided with two parallel extending crossbeams 4. Each crossbeam 4 in this case is guided inside a separate slide-in compartment 12, 12′ of the main frame 2. Each shuttle boom 3 in turn is provided with an energy-supply rod 5 that extends between the crossbeams 4.

The headpieces 6 adjoin the longitudinal-side free ends of the shuttle booms 3 and have longitudinal axes that are positioned crosswise to the axes for the crossbeams 4 of shuttle booms 3. The casing 8 with the locking pins 7 and the corner guides 9 are located at the ends of the headpieces 6.

Linear drives 37 are provided for realizing the displacement movement of the shuttle booms 3, wherein each linear drive 37 consist of a primary component 38 and a secondary component 39. FIG. 9 shows that a separate linear drive 37 is provided for each crossbeam 4 of the shuttle booms 3. The primary component 38 of a linear drive 37 is mounted stationary on the respective slide-in compartment 12, 12′ of main frame 2. The secondary component 39 of the respective linear drive 37 is mounted on the crossbeam 4 that extends inside the respective slide-in compartment 12, 12′.

The primary component 38 is provided with means for generating a magnetic field of traveling waves. The secondary component 39 consists of a metal rail, in particular an aluminum rail. This rail extends in longitudinal direction of the crossbeam 4, preferably over its total length.

The secondary component 39 is mounted on the crossbeam 4, such that it is at a constant, predetermined distance to the primary component 38 of the respective linear drive 37. In particular the roller bearings are used for this purpose and ensure that the distance between the primary component 38 and the secondary component 39 remains constant for optional displacement positions of the respective shuttle boom 3.

As a result of the field of traveling waves generated in the primary component 38 of a linear drive 37, corresponding alternating voltages are induced in the secondary component 39 and generate corresponding currents therein. The currents effect a force for moving the shuttle boom 3 in a predetermined direction. The forces required for moving the shuttle booms 3 are thus generated with the linear drives 37 without moving parts.

Each shuttle boom 3 is provided with a securing device, designed to stop the shuttle boom that moves in a predetermined direction and secure it in a specific position.

Each securing device is a brake 40, in the present case a block brake. Each brake 40 acts upon the energy-supply rod 5 of the respective shuttle boom 3.

FIG. 9 shows that the energy-supply rod 5 of a shuttle boom 3 extends between the crossbeams 4 of the respective shuttle boom 3 and is guided with its front end to the headpiece 6. The transverse girder 14, which has receptacles for guiding the energy-supply rods 5 for both shuttle booms 3, is provided inside the main frame 2 and extends crosswise to the longitudinal axes of the shuttle booms 3. The block brakes are positioned inside these receptacles, wherein the block brakes of brakes 40 are pushed against the outer surface of the energy-supply rods 5 in order to stop the shuttle booms 3.

FIG. 9 also shows that respectively one spiral cable 41 extends from the transverse girder 14 via the energy-supply rods 5 to the headpiece 6 for supplying power supply for the electrical units.

FIG. 10 shows a first arrangement of linear drives 37 at the crossbeams 4 of shuttle booms 3 for the lifting apparatus 1. The crossbeams 4 of the shuttle booms 3, which consist of steel in the present case, have a box-shaped design with a rectangular cross section. The cross sections for the inside spaces of the slide-in compartments 12, 12′ are adapted to the cross sections of the crossbeams 4 guided therein, so that the crossbeams 4 are guided with little play inside the respective slide-in compartments 12, 12′. For this, the crossbeams 4 are guided with roller bearings, as shown for the embodiments in FIGS. 1-8. This ensures that the outside walls of the crossbeams 4 extend respectively at a constant distance to the inside walls of the associated slide-in compartments 12, 12′.

The primary components 38 for the linear drives 37 are respectively inserted into a recess 42 of the corresponding slide-in compartment 12, 12′, so that the level top surface of the primary component 38 is flush with the surface of the adjacent inside wall of the respective slide-in compartment 12, 12′.

The secondary components 39 of linear drives 37 are respectively formed by metal rails, which are attached to the side wall of a crossbeam 4 that is facing the primary component 38. The top surface of a rail of this type preferably is flush with the top surface of the adjacent side wall of crossbeam 4. The primary components 38 and the opposite-arranged secondary components 39 preferably have identical structural heights.

FIG. 11 shows a second arrangement of linear drives 37 at the crossbeams 4 of shuttle booms 3 for the lifting apparatus 1. The slide-in compartments 12, 12′ again have a rectangular cross section, analog to the exemplary embodiment according to FIG. 10. The hollow spaces in the slide-in compartments 12, 12′, inside of which the crossbeams 4 are guided, in particular have a rectangular cross section.

The crossbeams 4 of shuttle booms 3 have an H-shaped cross section and are made of carbon-fiber compound materials in the present case.

Each crossbeam 4 consists of a support element 4a and two guide elements 4b, each having a rectangular cross section. The support element 4a extends nearly over the complete height of the cavity for the respective slide-in compartment 12, 12′, wherein its width is considerably smaller than the width of slide-in compartment 12, 12′. The flat side walls of the support elements 4a thus are at a distance to the side walls of the respective slide-in compartment 12, 12′. For this, the side walls of the support elements 4a extend in vertical planes, parallel to the side walls of the slide-in compartments 12, 12′. Resting on the upper and lower edge of the support element 4a is a separate guide element 4b, which is positioned in a horizontal plane and projects symmetrically over the side walls of the support element 4a. The top surface and the side surfaces of the upper guide element 4b are positioned at a short, constant distance to the inside walls of the slide-in compartments 12, 12′. In the same way, the underside and the side surfaces of the lower guide element 4b are positioned at a short, constant distance to the inside walls of the slide-in compartment 12, 12′. The guide elements 4b function to guide the crossbeam 4 inside the slide-in compartment 12, 12′, with the aid of the roller bearings described for the embodiments according to FIGS. 1-8.

With the exemplary embodiment according to FIG. 11, the primary components 38 of linear drives 37 are respectively attached to the inside of a side wall for the slide-in compartment 12, 12′. The secondary components 39 of linear drives 37, which are designed as metal rails, are respectively attached to the side surfaces facing the primary component 38 of the support element 4a of the respective crossbeam 4.

FIG. 11 shows that roller spacers 43, which are components of the roller bearings, are provided to keep each secondary component 39 at a constant distance to the primary component 38. The roller spacers 43 have holding brackets that are attached to the primary components 38 and have rollers mounted on the underside, which roll off the side wall of the support element 4a.

FIGS. 12-15 show exemplary embodiments of the lifting apparatus 1 according to the invention, originally disclosed in DE 101 40 449.

FIGS. 12 and 13 show a lifting apparatus 1 with a design that essentially corresponds to the lifting apparatus 1 design in FIGS. 1 and 2. In particular, the lifting apparatus 1 again has two shuttle booms 3, arranged displaceable on a main frame 2, wherein the shuttle booms 3 have respectively two parallel-extending crossbeams 4. Each crossbeam 4 is guided inside a separate slide-in compartment 12 or 12′ of the main frame 2. Each of the shuttle booms 3 in turn is provided with an energy-supply rod 5 that extends between the crossbeams 4 and serves as push rod.

The free longitudinal-side ends of the shuttle booms 3 are adjoined by head pieces 6, the longitudinal axes of which extend crosswise to the longitudinal axes of crossbeams 4 for shuttle booms 3. The casings 8 with the locking pins 7 and the corner guides 9, not shown in detail herein, are located at the ends of headpieces 6.

Two drum motors 44 are provided for carrying out the displacement movement of a shuttle boom 3, wherein each motor has an electrically driven, essentially cylindrical drum 45.

Each drum 45 in this case is positioned on a drive shaft 46.

The symmetry axes for drums 45, in which the respective drive shaft 46 extends, run crosswise to the longitudinal direction of the associated energy-supply rod 5. The drum motors 44 are thus arranged opposite each other on both sides of the energy-supply rod 5.

The energy-supply rod 5 has a rectangular cross section. The drum 45 of the first drum motor 44 rests against the top surface while the drum 45 of the second drum motor 44 rests against the underside of the energy-supply rod 5. The drums 45 are pushed against the energy-supply rod 5 with predetermined spring tension generated by a spring that is not shown herein. The drums 45 of drum motors 44 rotate in opposite directions and roll off the surfaces of the energy-supply rod 5, so that the shuttle boom 3 is displaced in longitudinal direction owing to the rotational movement of the drums 45.

It is essential that sufficiently high frictional forces are effective between the surfaces of drums 45 and the energy-supply rod 5 surface, so that the rotational movement of the drums 45 is converted without slippage to a translational movement of the energy-supply rod 5.

The outer surfaces of drums 45 are provided with a friction lining that is not shown herein. The friction lining consists of a wear-resistant rubber material or a glass-fiber containing plastic casting compound.

The top surface and the underside of the energy-supply rod 5 are also coated with a wear-resistant and friction lining that is not shown herein.

FIG. 14 shows a shuttle boom 3 guided inside the main frame 2 for the lifting apparatus 1, wherein the side walls of this shuttle boom have a lattice-type design, consisting of horizontal, vertical and slanted stays 47. Owing to the cavities between the stays 47, this shuttle boom 3 has a particularly low inherent weight. The arrangement of the stays 47 in accordance with FIG. 14 additionally results in high stability.

The advantages of the shuttle boom 3 are increased by the fact that the shuttle boom 3 consists of an especially dense material that is nevertheless capable of bearing heavy loads.

In particular, the shuttle boom 3 can consist of or at least in part of glass fiber materials or carbon-fiber compound materials. It is particularly advantageous if shuttle boom 3 elements subjected to tensile loads are made from glass fiber material while shuttle boom 3 elements subjected to pressure loads are made from carbon-fiber compound materials. A particularly high stability and load capacity of the shuttle boom 3 can be achieved in this way.

The shuttle boom 3 of one particularly advantageous embodiment of the invention is manufactured in a hybrid sandwich-style construction. In that case, the elements of shuttle boom 3 consist of several layers of glass fiber materials or carbon fiber compound materials.

FIG. 15 shows a detail of a crossbeam 4 for a shuttle boom 3, which is guided inside a slide-in compartment 12 of the main frame 2. A roller bearing is positioned on the underside of slide-in compartment 12, which functions to guide the crossbeam 4 in the slide-in compartment 12.

The roller bearing comprises rollers 15, 16, 17, 18 that are positioned inside roller blocks 48, wherein a roller 16 positioned inside a roller block 48 is shown in FIG. 15. The roller 16 is positioned inside the roller block 48 such that it can be displaced in vertical direction. The underside of crossbeam 4 of shuttle boom 3 rests on the roller 16.

A spring system is assigned to the roller 16, which essentially consists of a spring leaf 49 that is positioned on the side in spring retainers 50. The spring leaf 49 preferably is made of steel and extends in horizontal direction. The spring retainers 50 extend in vertical direction and project downward from the underside of the slide-in compartment 12. An extension 51 is provided on the top of spring leaf 49, which is located directly below the roller 16.

During a load engagement of the shuttle boom 3, particularly if the shuttle boom 3 moves downward with a jerky movement, the roller 16 is pushed downward inside the roller block 48. The spring system dampens and limits the movement. In the process, the roller 16 pushes against the extension 51, so that the spring leaf 49 is somewhat bent through in downward direction, as shown with dashed lines in FIG. 15.

A flat support element 52 is respectively provided on the inside walls on the top and bottom of the slide-in compartment 12. The support elements 52 are arranged opposite each other, wherein the lower support element 52 is located in the area of the roller bearing. The support elements 52 serve to better guide the crossbeam 4 inside the slide-in compartment 12, wherein the surfaces of the crossbeams 4 rest on the support elements. The support elements 52 preferably are made of plastic, in particular polyethylene.

List of Reference Numbers

(1) lifting apparatus

(2) main frame

(3) shuttle boom

(4) crossbeam

(4a) support element

(4b) guide element

(5) energy supply rod

(6) head piece

(7) locking pin

(8) casing

(9) corner guide

(10) electric motor

(11) toothed belt

(12) slide-in compartment

(12′) slide-in compartment

(13) bore

(14) transverse girder

(15) roller

(16) roller

(17) roller

(18) roller

(19) buffer plate

(19′) buffer plate

(20) roller block

(21) holder

(22) spring

(23) support plate

(24) spring buffer

(25) plastic lining

(26) shoulder

(27) plastic lining

(28) plastic bearing

(29) projection

(30) electric motor

(31) head piece—push rod

(32) bearing

(33) holder

(34) solid-steel plate

(35) buffer

(36) planetary gear

(37) linear drive

(38) primary component

(39) secondary component

(40) brake

(41) spiral cable

(42) recess

(43) roller spacer

(44) drum motor

(45) drum

(46) drive shaft

(47) stays

(48) roller block

(49) spring leaf

(50) spring retainer

(51) extension

(52) support element

1. A lifting apparatus for transporting a container, said device comprising a main frame and two shuttle booms, wherein respectively one shuttle boom is positioned such that it exits at one longitudinal-side end of the main frame and can be moved in longitudinal direction of the main frame and wherein the free ends of the shuttle booms are provided with holders for attaching the container, characterized in that the shuttle booms (3) and/or the holders are operated by means of an electric drive and that the shuttle booms (3) are guided with roller bearings inside a main frame (2).

2. A lifting apparatus according to claim 1, characterized in that the shuttle booms (3) are made of carbon fiber compound materials or of steel.

3. A lifting apparatus according to one of the claims 1 or 2, characterized in that the electric drive comprises two electric motors (10), wherein each electric motor (10) respectively drives a toothed belt (11), which engages in an energy-supply rod (5) on a shuttle boom (3).

4. A lifting apparatus according to claim 3, characterized in that the shuttle booms (3) have identical designs and are respectively provided with two crossbeams (4), arranged parallel and at a distance to each other, which are guided inside slide-in compartments (12, 12′) of the main frame (2) and between which the energy-supply rod (5) of the respective shuttle boom (3) extends.

5. A lifting apparatus according to claim 4, characterized in that the crossbeams (4) of the shuttle booms (3) are guided respectively displaced to the side inside the main frame (2), wherein a separate slide-in compartment (12, 12′) is provided for each crossbeam (4).

6. A lifting apparatus according to one of the claims 1-5, characterized in that the roller bearings are provided with rollers (15, 16, 17, 18), the rotational axes of which extend crosswise to the longitudinal axis of the respective shuttle boom (3).

7. A lifting apparatus according to claim 6, characterized in that the rollers (15, 16, 17, 18) are made of polypropylene or rigid expanded polyurethane.

8. A lifting apparatus according to one of the claims 6 or 7, characterized in that the rollers (15, 16, 17, 18) are positioned with springs.

9. A lifting apparatus according to one of the claims 6-8, characterized in that the crossbeam (4) back, positioned inside the main frame (2), of each shuttle boom (3), is provided with two opposite-arranged rollers (15, 16) on the crossbeam (4), wherein the first roller (15) projects over the top surface of crossbeam (4) and the second roller (16) projects over the underside of crossbeam (4), so that these rollers rest against the inside walls of the respective slide-in compartment (12, 12′).

10. A lifting apparatus according to claim 9, characterized in that the first and second rollers (15, 16) respectively rest on a roller block (20), wherein the roller block (20) is positioned on a spring (22).

11. A lifting apparatus according to one of the claims 6-10, characterized in that a third roller (17), which is positioned on the underside of the respective slide-in compartment (12, 12′), is provided at each exit of each slide-in compartment (12, 12′), on which the crossbeam (4) of a shuttle boom (3) ends and that the underside of the respective crossbeam (4) is guided on this roller.

12. A lifting apparatus according to one of the claims 9-11, characterized in that the first, the second and the third rollers (15, 16, 17) respectively extend over the complete width of a crossbeam (4).

13. A lifting apparatus according to one of the claims 11 or 12, characterized in that the third rollers (17) are respectively positioned on a spring buffer (24).

14. A lifting apparatus according to claim 13, characterized in that the spring buffer (24) consists of “Vulkullan.”

15. A lifting apparatus according to one of the claims 11-14, characterized in that each third roller (17) is assigned a buffer plate (19, 19′), which is arranged opposite the roller on the top of the respective slide-in compartment (12, 12′) for guiding the respective crossbeam (4).

16. A lifting apparatus according to one of the claims 6-15, characterized in that additional rollers (18) for the side guidance of the respective crossbeam (4) project from the insides of the side walls of each slide-in compartments (12, 12′).

17. A lifting apparatus according to one of the claims 1-16, characterized in that respectively one head piece (6) is glued onto the free longitudinal-side ends of the shuttle booms (3) for positioning the holders.

18. A lifting apparatus according to claim 17, characterized in that layers of Vulkollan (25, 27) are provided as adhesive layers between a shuttle boom (3) and the respective head piece (6).

19. A lifting apparatus according to claim 18, characterized in that at least one layer of Vulkollan (27), which forms a buffer, is positioned between the underside of the respective shuttle boom (3) and a shoulder (26) of the head piece (6).

20. A lifting apparatus according to one of the claims 17-19, characterized in that electrically operated locking pins (7) are provided at the free ends of a head piece (6) that project on the side over a shuttle boom (3).

21. A lifting apparatus according to claim 20, characterized in that the locking pins (7) are operated with electric motors (30).

22. A lifting apparatus according to one of the claims 17-21, characterized in that at the free ends of a head piece (6) that project on the side over a shuttle boom (3), electrically operated corner guides (9) are provided as holders for positioning on a container.

23. A lifting apparatus according to claim 22, characterized in that planetary gears (36) are provided for realizing the pivoting movements of corner guides (9).

24. A lifting apparatus according to claim 22, characterized in that rotation magnets are provided for realizing the pivoting movements of corner guides (9).

25. A lifting apparatus according to claim 1, characterized in that at least one linear drive (37) is provided for driving each shuttle boom (3).

26. A lifting apparatus according to claim 25, characterized in that each crossbeam (4) of the shuttle booms (3) is driven via a separate linear drive (37).

27. A lifting apparatus according to claim 26, characterized in that each linear drive (37) comprises a primary component (38) that is positioned stationary at the slide-in compartment (12, 12′) associated with the crossbeam (4) and a secondary component (39) in the form of a metal rail, which extends in longitudinal direction of the respective crossbeam (4).

28. A lifting apparatus according to claim 27, characterized in that each secondary component (39) extends over the complete length of a shuttle boom (3).

29. A lifting apparatus according to one of the claims 27 or 28, characterized in that the surfaces of the primary component (38) and the secondary component (39), which are facing each other, are kept at a constant distance to each other by means of roller spacers (43).

30. A lifting apparatus according to claim 29, characterized in that the rollers spacers (43) form a part of the roller bearings.

31. A lifting apparatus according to one of the claims 25-30, characterized in that a securing device is provided for fixing a shuttle boom (3) in a predetermined displacement position.

32. A lifting apparatus according to claim 31, characterized in that the securing device is a brake (40) that acts upon the energy-supply rod (5) of the respective shuttle boom (3).

33. A lifting apparatus according to claim 32, characterized in that the brake (40) is a block brake.

34. A lifting apparatus according to claims 25-33, characterized in that each crossbeam (4) of a shuttle boom (3) has a rectangular cross section, the cross-sectional surface of which is adapted to the cross-sectional surface of the cavity of the associated slide-in compartment (12, 12′) and that the primary component (38) of a linear drive (37) is inserted into a recess (42) in one side wall of one slide-in compartment (12, 12′), so that the primary component (38) is positioned opposite the secondary component (39) of the linear drive (37), which is arranged on one side wall of crossbeam (4).

35. A lifting apparatus according to claims 25-33, characterized in that each crossbeam (4) has an H-shaped cross section and consists of a support element (4a) and two guide elements (4b), wherein the side walls of the support element (4a), which extend in vertical planes, are at a distance to the parallel extending side walls of the associated slide-in compartment (12, 12′), and wherein respectively one guide element (4b) rests on the top and underside of the support element (4a), so that these project over the side walls of the support element (4a) and fit tightly against the insides of the slide-in compartment (12, 12′).

36. A lifting apparatus according to claim 35, characterized in that the support element (4a) and the guide elements (4b) of a crossbeam (4) respectively have a rectangular cross section.

37. A lifting apparatus according to one of the claims 35 or 36, characterized in that the widths of the guide elements (4b) are adapted to the widths of the slide-in compartment (12, 12′).

38. A lifting apparatus according to one of the claims 35-37, characterized in that the primary component (38) of the electric motor (30) is arranged on the inside of the side wall for the slide-in compartment (12, 12′) and that the secondary component (39) is arranged such that it extends along one side wall of support element (4a) in longitudinal direction.

39. A lifting apparatus according to claim 1, characterized in that the electric drives are drum motors (44) and that each shuttle boom (3) has an energy-supply rod (5) that is clamped between two drums (45) of two drum motors (44), wherein the energy-supply rod (5) can be displaced by turning the drums (45).

40. A lifting apparatus according to claim 39, characterized in that the energy-supply rod (5) has a top side and an underside, on which the drums (45) of a drum motor (44) can respectively roll off.

41. A lifting apparatus according to one of the claims 39 or 40, characterized in that a friction lining is installed on the outer surface of the drums (45) of drum motors (44).

42. A lifting apparatus according to claim 41, characterized in that the friction lining consists of a wear-resistant rubber material or a glass-fiber containing plastic casting compound.

43. A lifting apparatus according to one of the claims 40-42, characterized in that a friction lining is applied to the top side or underside of each energy-supply rod (5).

44. A lifting apparatus according to one of the claims 39-43, characterized in that the drums (45) of drum motors (44) are pushed with spring tension against the energy-supply rod (5).

45. A lifting apparatus according to one of the claims 39-44, characterized in that the walls of the shuttle booms (3) have a lattice-type design, at least in some sections.

46. A lifting apparatus according to claim 45, characterized in that at least some elements of a shuttle boom (3) consist of glass fiber materials.

47. A lifting apparatus according to one of the claims 45-46, characterized in that at least some elements of a shuttle boom (3) are designed in the form of hybrid sandwich-type elements, consisting of layers of glass fiber materials and carbon fiber compound materials.

48. A lifting apparatus according to one of the claims 45-47, characterized in that elements of the shuttle boom (3), which are subjected to tensile loads, are made from glass fiber materials and that elements of the shuttle boom (3) that are subjected to pressure loads are made from carbon fiber compound materials.

49. A lifting apparatus according to one of the claims 39-48, characterized in that roller blocks (48) are provided on the main frame (2), inside of which the rollers of the roller bearings are positioned displaceable.

50. A lifting apparatus according to claim 49, characterized in that spring leaves (49) that form spring systems are provided on the roller blocks (48), against which the rollers of the roller bearings are pushed in case of a load engagement of shuttle boom (3).

51. A lifting apparatus according to claim 50, characterized in that each spring leaf (49) is positioned between two spring retainers (50).

52. A lifting apparatus according to one of the claims 50 or 51, characterized in that the shuttle booms (3) are provided with crossbeams (4) that are guided inside slide-in compartments (12, 12′), wherein the spring leaves (49) are arranged on the undersides of the slide-in compartments (12, 12′).

53. A lifting apparatus according to claim 52, characterized in that flat support elements (52) for guiding the crossbeams (4) of shuttle booms (3) are provided on the inside walls of the slide-in compartments (12, 12′).

54. A lifting apparatus according to claim 53, characterized in that the support elements (52) are arranged in pairs on opposite insides of the slide-in compartments (12, 12′).

55. A lifting apparatus according to one of the claims 53 or 54, characterized in that the support elements (52) are made from plastic.
